(19) United States
(12) Patent Application Publication
(10) Pub. No.: US 2026/0242259 A1
(43) Pub. Date: Aug. 20, 2026

(54) MAGNETIC MOLECULAR RESONATOR FOR WATER AND OTHER FLUIDS

(71) Applicants: Darko Kostantinovic; Ivan Šprah, Maribor (SI)

(72) Inventors: Darko Kostantinovic; Ivan Šprah, Maribor (SI)

(21) Appl. No.: 19/472,020

(22) PCT Filed: Apr. 4, 2024
(86) PCT No.: PCT/IB2024/053311

§ 371 Date: Oct. 2, 2025

(30) Foreign Application Priority Data
Apr. 6, 2023 (SI) P-202300044

(51) Int. Cl. C02F 1/48; C02F 1/00; C02F 5/00

(52) U.S. Cl. CPC C02F 1/482; C02F 1/005; C02F 5/00; C02F 2301/022; C02F 2307/14

(57) ABSTRACT

The magnetic molecular resonator solves the problem of ecologically durable cleaning of limescale in water systems and devices connected to water systems, as well as the problem of deposits with other fluids. It is durable and does not require servicing. It keeps the water clean and does not change the mineral composition of the water or other fluids. It increases the surface tension of water and fluids, which contributes to greater fluidity or capillarity. It is useful in all areas where the main medium is water or other fluids.

Any number of symmetrical pairs of permanent magnets or materials (2) of the same magnetic current density, sorted onto paramagnetic or diamagnetic tube (3), different pairs of angular shapes (5, 6, 7) and ferromagnetic plate (1) are inseparably integrated together in the carrier housing (8) of various geometric shapes. Permanent magnets or materials (2) of the same magnetic field density are sealed watertight in the compartments of the compartment carrier in such a position, that the direction of the water flowing through the device intersects the magnetic lines at right angles. It does not require additional energy or maintenance, installation is quick and easy.

### BACKGROUND

The subject of the invention is a ferromagnetic plate on a magnetic molecular resonator for water and other fluids, which directs parahydrogen and ortho-hydrogen atoms with the help of permanent (ceramic) magnets placed alternately north-south or similar materials of the same magnetic current density. With the invention, we increase the resonance of the magnetic current density in a paramagnetic or diamagnetic tube (of different geometric shapes), so that in combination with a ferromagnetic plate, placed on magnets that are placed alternately north-south or similar materials of the same magnetic current density, we create a strong resonance, which with the help of the kinetic energy of the fluid or the water removes deposits of various deposits and also prevents the formation of new ones.

According to the international patent classification, the invention belongs to B 03C 1/14 and additionally to C 02F 1/48 and C 02F 5/00.

### DETAILED DESCRIPTION OF THE INVENTION, RELATED ART AND BRIEF DESCRIPTION OF THE DRAWINGS

The technical problem, solved by the invention, is a combination of tubes (of different shapes) made of paramagnetic or diamagnetic material, permanent (ceramic) magnets or materials with the same magnetic current density, placed alternately north-south, and a ferromagnetic plate placed on the magnets themselves or materials with the same magnetic flux density. Such a combination increases both the strength of magnets or materials with the same magnetic current density, as well as the resonance of liquids. The combination of a paramagnetic or diamagnetic tube (of various shapes), natural magnets or materials with the same magnetic current density placed alternately north-south and a ferromagnetic plate is the subject of the invention.

A magnetic molecular resonator of water and other fluids with one or more active fields directs para-and ortho atoms in fluids, so that they adhere laminarly and are easier to clean with the help of the kinetic energy of water or other fluids. They also increase the surface tension of water or other fluids, which can be used everywhere where there is increased fluidity or capillarity. Permanent magnets or similar materials 2 of the same magnetic current density are placed on a paramagnetic or diamagnetic tube 3 made of materials, which guarantee that the fluids flowing through these pipes are safe for consumption or stainless materials of various geometric shapes 5, 6, 7 and are surrounded by a ferromagnetic plate 1 of different dimensions.

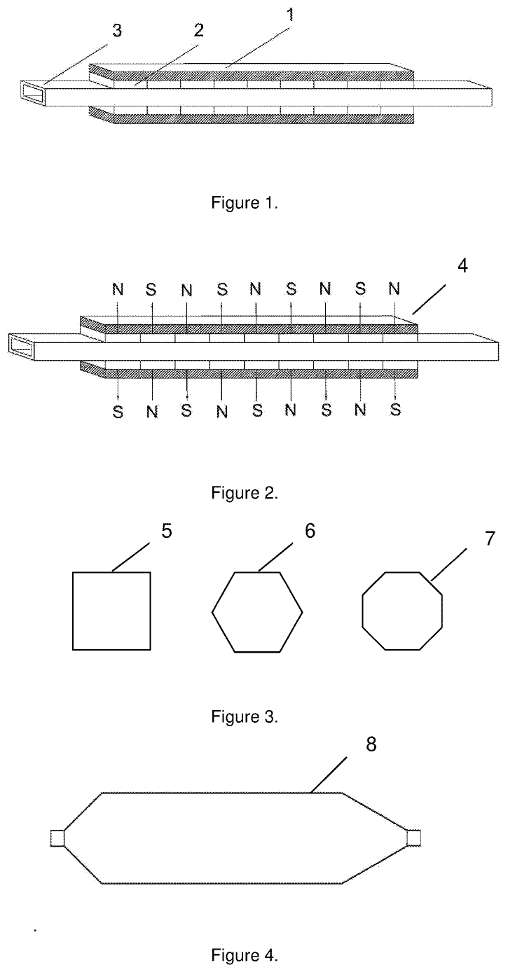

Permanent magnets or similar materials 2 that we use are placed in the basic resonator of one active pole in such a way that the ends of the two end magnets, which are placed alternately north (N)-south(S) or in the reverse order form the same pole 4 and that the direction of the water jet or fluid flow is perpendicular to the direction of the magnetic force lines and intersects them, as shown in FIG. 2. The magnetic molecular resonator can also be implemented in a multipole version, where the poles are (any number depending on the amount of flow) are arbitrarily arranged in a carrier pipe or element of 8 different geometric shapes made of stainless steel or some other stainless material and there are empty chambers between them that can be filled with suitable material, or they can be combined in several rows or concentrically circular, depending on the direction of the flow. The magnetic molecular resonator is made with different types of connections (threaded, flanged), of various geometric shapes and conical or semicircular finishes, which, depending on the needs, is mounted on pipes or devices that use water or other fluids for operation.

There are many well-known solutions for different laminators of water or liquids, but no one cleans the resulting deposits that occur during settling. With the combination we are applying, we have solved this problem, and to the best of our knowledge, no one is using such a constellation. In all cases of similar devices, magnets are placed on a tube and enclosed in an individual device.

According to the invention, the problem of cleaning water or liquid deposits is solved in such a way that the device can be installed in all water installations and devices connected to the water system. The invention will be described using an embodiment and figures showing one active pole, which can be increased or decreased and assembled as needed, depending on the flow of water or fluids.

Pipes 5, 6, 7, which are used as a base and are made of paramagnetic or diamagnetic material or treated to become paramagnetic, can be of different shapes and thickness between 2 and 8 mm and different dimensions of the flow field, but always even-angled, except for the round pipe and if they are produced from Inox or some other stainless material.

Magnets 2, which we use for the assembly, are permanent (ceramic) NdFeB magnets (composed of nickel, neodymium, boron and iron) versions N48M or N52 with a strength between 0.5 T and 2 T or similar materials of the same magnetic flux density.

The ferromagnetic plate 1, which is placed on magnets or similar materials 2, can cover them, partially cover them or, if necessary, have larger dimensions and is made of materials that attract magnets.

From Slovenian patent application P-9400266, a device for ecologically sound water softening is known. According to this document, at least one pair of permanent magnets is placed symmetrically in the pockets, in the supporting base, shaped like an ellipsoidal ring. The disadvantage of this solution lies in the complex manufacturing, further in the fact that the permanent magnets are not protected against the influence of water and in this, it gives priority intended only for use within users, in boilers, in household appliances, in tanks and the like. The peculiarity of this well-known solution is also that it provides, for the symmetrical installation of permanent magnets, exclusively in one plane and that it does not contain a more precise technical solution for the construction of the device.

The magnetic molecular resonator for water and other fluids according to the invention does not require any maintenance and does not break down.

1. Magnetic molecular resonator for water and other fluids
Characterized in that
that the combination of a ferromagnetic plate (1) placed on magnets or other material (2) of the same magnetic density, surrounding a paramagnetic or diamagnetic tube (3), which form a magnetic molecular resonator of water and fluids with one or more active fields, which directs para and ortho atoms in fluids so that they adhere laminarly and are easier to clean with the help of the kinetic energy of water or fluids, they also increase the surface tension of water or fluids, which can be used everywhere where increased fluidity or capillarity is needed and that permanent magnets or similar materials (2) used in the basic resonator are of one active pole re placed in such a way that the ends of the two end magnets, which are placed alternately north (N)-south(S) or in the reverse order on the paramagnetic or diamagnetic tube, they form the same pole (4), as well as permanent magnets or similar materials (2) of the same magnetic current density are placed on paramagnetic or diamagnetic tubes (3), which are produced from materials, which guarantee that the fluids flowing through these pipes are safe for consumption or other stainless materials of various geometric shapes (5, 6, 7) and that the poles, an arbitrary number depending on the amount of flow, are arbitrarily arranged in a carrier tube or element (8) of different geometric shapes made of stainless steel or some other stainless material.
